(19) United States
(12) Patent Application Publication
(10) Pub. No.: US 2026/0257618 A1
(43) Pub. Date: Sep. 3, 2026

(54) ILLUMINATING DEVICE FOR THE INTERIOR OF A MOTOR VEHICLE, AND MOTOR VEHICLE

(71) Applicant: AUDI AG, Ingolstadt (DE)

(72) Inventors: Sarkis BENLIYAN, Ingolstadt (DE); Andreas GASTL, Buxheim (DE)

(21) Appl. No.: 19/159,959

(22) PCT Filed: Mar. 1, 2024
(86) PCT No.: PCT/EP2024/055309

§ 371 Date: Aug. 26, 2025

(30) Foreign Application Priority Data
Mar. 6, 2023 (DE) 10 2023 105 469.4

(51) Int. Cl. B60Q 3/60; B60Q 3/233; B60Q 3/54; B60Q 3/80

(52) U.S. Cl. CPC B60Q 3/60; B60Q 3/233; B60Q 3/54; B60Q 3/80

(57) ABSTRACT

An illuminating device is provided for an interior of a motor vehicle, such as for a trim part and/or a backrest of a seat. The illuminating device includes a passive lighting element which defines an outer lighting surface having a light-emission direction; and at least two light sources which can be switched differently; wherein a first light source shines through the lighting element in the light-emission direction for illumination, and wherein, in order to define the lighting surface, the lighting element is translucent in the light-emission direction in at least one region defining a first lighting pattern and is reflective in at least one region defining a second lighting pattern. A second light source is provided for illuminating the outside of the lighting element such that light from the second light source that hits the lighting element from the outside is reflected in the light-emission direction by the reflective region.

### BACKGROUND

### Technical Field

The disclosure relates to an illuminating device for an interior of a motor vehicle, such as for a trim part and/or the backrest of a seat. The disclosure, moreover, relates to a motor vehicle with such an illuminating device.

### Description of the Related Art

Illuminating devices, in particular for the provision of ambient light, have long been used in motor vehicle interiors. By way of example, in order to meet design needs, it has been proposed to use light guides that can be integrated into trim and functional parts of the interior. Light guides have the advantage of requiring little installation space and providing a certain degree of flexibility in terms of shaping and/or formability, so that they can also, for example, be arranged around corners and with changing pathways. The aspect of installation space, due to the limited availability, is often a relevant consideration, especially in the interior of the motor vehicle, which comprises a large number of useful elements and associated components.

With regard to novel designs in conjunction with robust, reliable functionality, various other designs have already been proposed in the state of the art that deviate from simple light guides and provide novel ways of emitting useful, information and ambient light. For this reason, indirect illuminating devices have been proposed in the prior art in which reflector surfaces are used to direct light into the interior, particularly from light sources installed in a concealed manner. For example, a door construction has been proposed that has a light source on the outward-facing side, wherein the light can enter the interior of the motor vehicle as ambient light through a slot or similar.

Other approaches, which have been common for some time, use backlighting or alternatively the shining through of passive lighting elements. The corresponding lighting element, which is not configured to illuminate by itself but requires light input from the light source, can comprise translucent regions in the region of an outward-facing lighting surface, behind which at least one light source is arranged. A large number of variants have already been proposed in the prior art in order to achieve the most diffuse and therefore most uniform illumination of such a translucent region without the light source behind it becoming visible. Techniques are, moreover, already known in the state of the art to conceal the existence of the translucent region from view when the light source is deactivated, so that, for example, a trim part with such an illuminating device can appear with a continuous, uniform surface when the light source is deactivated, on which surface a useful and/or information and/or ambient light can then appear to create a special design effect when the light source is activated.

It has also already been proposed to integrate such known concepts with light guides, which act, in particular, as a diffuse light source in order to further increase the design freedom.

DE 102012 100 816 A1 discloses a vehicle light for a motor vehicle with at least one light function element serving as a light guide and reflector, with which a plurality of light sources interact such that a first region of the respective light function element serves as a reflector for the light emitted by a first light source and a second region of the respective light function element serves as a light guide for the light emitted by a second light source. Correspondingly, the resulting light-exit surfaces are spatially separated so that, for example, the first light source can provide a stop light function and the second light source can provide a tail light function. Other possible functions for the vehicle light intended for outdoor use include indicator and position lights.

DE 10341 739 A1 relates to an interior light for a motor vehicle, which has a housing. A first light source and a reflector are arranged inside the housing. A lens closes off the housing. The lens or the reflector can form a light guide, wherein a second light source couples light into a side surface of the lens or the reflector and wherein the lens or the reflector has imperfections which scatter the light, that has been coupled into the lens or the reflector by the second light source, into the interior of the motor vehicle. The aim here is to create a combination of area light and incident light, for example, as a reading light.

DE 102018 205 352 B4 discloses a light strip for a motor vehicle with a plurality of light sources arranged side by side along a row. The row extends in an intermediate space which is configured by a first reflective element and a second reflective element, wherein the first reflective element has at least one fully reflective mirror surface and the second reflective element has at least one semi-transparent mirror surface, so that as a function of a luminous intensity of the respective light source (“endless mirror” effect), a certain number of reflections are produced in the respective mirror surfaces of the two reflective elements.

DE 102009 060 355 B4 relates to an illuminating device for the interior of a vehicle, which has a base body for accommodating at least one light source. A flat first light guide body of the base body and a flat second light guide body of the base body are respectively connected to a first and a second light source, wherein the second light guide body is arranged such that the light coupled out of the second light guide body radiates through the first light guide body. The illuminating device can, for example, be installed in the headliner of a vehicle.

### BRIEF SUMMARY

Embodiments of the present invention provide a novel design of an illuminating device for the interior of a motor vehicle, which, in particular, provides new lighting effects for useful and/or ambient and/or information light.

In particular, an illuminating device is provided that includes a passive lighting element, which defines an outer lighting surface having a light-emission direction, and at least two light sources which can be switched differently, wherein a first light source shines through the at least partially translucent lighting element in the light-emission direction for illumination. It is further provided according to the disclosure that in order to define the lighting surface, the passive lighting element of the illuminating device is configured to be translucent in the light-exit or light-emission direction in at least one region defining a first lighting pattern and to be reflective in at least one region defining a second lighting pattern. A second light source is provided for illuminating the outside of the passive lighting element such that light from the second light source that hits the lighting element from the outside is reflected in the light-exit or light-emission direction by the reflective region, and the passive lighting element is designed at least in the translucent region such that the first lighting pattern and/or the second lighting pattern cannot be recognized from the outside when the first light source is switched off.

The passive lighting element therefore does not act as a light source itself, but only lights up when at least one of the two light sources is activated. The term light-exit or light emission direction is to be understood broadly as an outwardly directed spatial angle region emanating from and/or encompassing the lighting surface. When the light sources are in operation, it therefore appears to a user as if the lighting patterns of the lighting surface are illuminated. Here, the first lighting pattern and the second lighting pattern are to be understood as part of a common, coherent lighting surface, wherein the lighting patterns can optionally overlap, but preferably at least interlock and/or are otherwise interwoven with one another.

According to the disclosure, it is proposed to provide two separate, simultaneously operating systems based on different principles in a common illuminating device in order to provide a variety of novel light manifestations. A second subsystem of the illuminating device is based on the reflection of light on a surface, which is to say, based on indirect illumination in which no direct light source is visible. In other words, a particularly advantageous design of the present disclosure provides for the second light source to be installed in a concealed manner, in particular with regard to the light-exit or light emission direction. The first subsystem is based on light that shines through another material, in this case the at least one material of the passive lighting element, which is designed to be translucent in some regions. This can be understood as a kind of “static shadow play”. The passive lighting element therefore acts as a template for the first light source.

The subsystems and in particular the lighting patterns can be used independently of each other and can complement and reinforce each other, in particular in a variety of color variations and light intensities, in order to create completely new atmospheres. An advantageous design of the present disclosure provides that both subsystems are designed to emit ambient light. However, in principle, other variants in which at least one of the subsystems emits useful and/or information light are also conceivable. In the latter case, at least one of the lighting patterns can therefore be designed to emit information.

The illuminating device according to the disclosure can be used to create visually interesting and/or mood-spreading lighting surfaces within the motor vehicle. Since extremely compact solutions are already known for the respective subsystems, integration in the smallest of spaces can also be realized for the illuminating device according to the disclosure, wherein a large number of possibilities and different light manifestations can be provided at the same time. The first subsystem can be described as through-light, the second subsystem can be described as overhead-light.

If only the first light source is operated, then only the first lighting pattern is visible. If the second light source is operated alone, only the second lighting pattern appears. When both light sources are in operation, both lighting patterns are active. It is, moreover, advantageous if, when the light sources are switched off, the associated lighting patterns, which may, for example, be realized as graphics are not visible.

The disclosure provides for the passive lighting element to be designed, at least in the translucent region, such that the first lighting pattern and/or the second lighting pattern cannot be recognized from the outside when the first light source is switched off. In this way, an excellent visual impression is created even if none or only one of the two light sources is operated. By way of example, it can, specifically, be provided that the non-recognition is given by a material treatment selected to generate the translucent region and/or the reflective region. By way of example, laser treatments and/or etching processes and/or other precision processes can be used to provide the first and/or the second lighting pattern, in particular as a precision pattern, not only with excellent quality and accuracy, but also such that it is not visible in an unlit situation. The lighting element, which can, in particular, be designed at least substantially in the shape of a plate, can, for example, comprise or consist of a specific material, such as a plastic, which is locally modified by the material treatment, as is generally known in the prior art, in order to bring about the desired property, which is to say, translucency and/or reflection. Designs are, however, also conceivable in which a base body, for example, made of plastic, is provided with a cover layer, for example, made of a lacquer and/or a film, and the material treatment is carried out on the lacquer in order to achieve the desired property locally and with high precision such that the change, in particular macroscopically, is not or hardly recognizable.

Alternatively, or additionally, it is also conceivable that the non-recognition is provided by an outer layer that is at least translucent in the light-exit or light-emission direction and at least partially opaque in the direction opposite to the light-exit or light-emission direction and/or by an outer layer that has a light-diffusing structure and/or light-diffusing inclusions.

It is, moreover, expedient if, at least when the first light source is not in operation, and advantageously also when the first light source is in operation, it is not or alternatively not specifically recognizable through the lighting element, behind which it is arranged. It can therefore be envisaged, for example, that the translucent region is at least so opaque in the direction opposite the light-exit or light-emission direction that the first light source is not visible when viewing the lighting surface from the outside, at least when it is switched off. It is, however, particularly advantageous in this context if the translucent region is at least light-diffusing for light from the first light source. This results in a uniform, visually appealing design of the first lighting pattern.

A particularly expedient design is one in which a base body of the lighting element is supplemented by layers, for example, of lacquer, and/or foils and, if necessary, materially-processed such that both the desired lighting patterns and desired further properties, in particular the non-recognition of the lighting patterns, result. Here, for example, different layers and/or films can be provided for the provision of the first and second lighting patterns, which can be followed by at least one further film or layer for concealing the lighting patterns (and, in particular, also objects located behind the lighting element, for example, the first light source), for example, by covering them on the outside.

As already mentioned, the basic design by combining the two subsystems provides a very high degree of flexibility with regard to lighting impressions of the lighting surface, which can be filled at least partially statically and/or at least partially dynamically. For example, the design of the translucent and reflective regions can already result in certain, advantageously different, light impressions. An expedient design therefore provides that the translucent and the reflective region are configured to generate different light impressions, in particular different light diffusion and/or light color and/or color temperature and/or light intensity. This means that the basic requirements for the desired light manifestations can already be provided in the specific design, particularly with regard to the differences between the subsystems.

Also, when speaking of the light sources, a certain characteristic can already be at least partially statically predetermined. It is, for example, possible for the first and second light sources to emit light with at least one different characteristic, in particular different light color and/or color temperature and/or light intensity. In particular, in this way, an easily controllable design that fits perfectly into the overall design of a motor vehicle interior can be achieved.

It may, however, be particularly advantageous for the illuminating device to also have a control unit for controlling the operation of the light sources. In particular, the control unit can be configured to provide at least four basic operating modes, namely a switched-off operating mode in which no light source is operated, two individual operating modes in which only one of the light sources is operated in each case, and a combination operating mode in which both light sources are operated. This already provides a basic, easy-to-implement variability of the lighting appearance.

It can, however, be provided with particular advantage that at least one of the light sources can be controlled with respect to at least one property of the emitted light, in particular the light color and/or color temperature and/or light intensity, in order to change it. In this way, it is possible, for example, to provide an illuminating device that can be adjusted both to its specific place of use, for example, a general interior design, and to the personal preferences of a user, for example, a driver or other occupant. Here, adjustability and corresponding controllability can be provided by way of the control unit, for example, by way of an operating device of the motor vehicle, yet also automatically, for example, as part of a comfort system that adapts the ambience in the interior, in particular also the ambient lighting, to a current mood and/or known preference and/or color selection of the user. Not only can occupants of the motor vehicle then be delighted by the variety of possible lighting designs, but a certain magic can also be introduced into the motor vehicle, which can positively influence the well-being of all occupants.

A particularly advantageous design also results if the control unit is configured for dynamic operation of at least one of the light sources to create a dynamic light impression of the lighting surface. Whereas a certain dynamic can also be achieved by activating and deactivating the light sources, there is a particularly large scope for creativity if the light sources can be controlled with variable light color and/or color temperature and/or light intensity. By way of example, animated lighting surfaces with a lively or calming design can then be provided. This can lead to the creation of certain, completely new, desired atmospheres.

In a specific design, the first light source and/or the second light source can comprise at least one LED and/or be extended in at least one direction. LEDs can be realized with a particularly small design and are particularly suitable for confined installation spaces in motor vehicles. Specifically, LED matrices and/or LED arrays, for example, LED strips, can be used, particularly advantageously for the second light source. An extended design is particularly suitable for the second light source in order to achieve the most uniform possible light irradiation on the reflective region so that the second lighting pattern appears evenly illuminated. For example, LED strips are suitable here. For the first light source, as already mentioned, a uniform light appearance can also be achieved in other ways, for example, by a light-diffusing design of the lighting element at least in the translucent region.

In a specific design of the present disclosure, it may be provided that the lighting element is inclined towards the horizontal and the vertical at least in the region of the lighting surface and that the second light source is arranged above the lighting surface. Such a design is particularly suitable for integration in seat backs or other surfaces that are at least substantially vertical. In particular, the illuminating device can then manifest itself as an indentation in the vertically extending surface, wherein the second light source is installed in a concealed manner at the top of the indentation and the visible part of the indentation at least partially forms the lighting surface. A comparable design is also possible with a laterally irradiating illuminating surface inclined about a vertical axis.

In a particularly advantageous further development of the present disclosure, it is provided that the illuminating device is configured as a light module with a support comprising the lighting element, to which support the light sources are attached. This results in a coherent part that can be used in the interior of the motor vehicle, which can be used in various positions in the motor vehicle, particularly in a modular design. Specifically, the light module can, for example, be configured for insertion into a trim part of the motor vehicle, with the support having a surface that continues the surface of the trim part and comprises the lighting surface. In particular, when light is irradiated from above or from the side onto an inclined lighting surface by the second light source, extremely small and therefore space-saving light modules can be achieved, which can even be used in the tight installation space in the automotive interior.

In addition to the illuminating device, the present disclosure also comprises a motor vehicle which has at least one illuminating device of the type according to the disclosure, such as in a trim part and/or a backrest of a seat. All explanations relating to the illuminating device according to the disclosure can be transferred analogously to the motor vehicle according to the disclosure, with which the already mentioned advantages can therefore also be obtained.

### BRIEF DESCRIPTION OF THE SEVERAL VIEWS OF THE DRAWINGS

Further advantages and details of the present disclosure emerge from the embodiment examples described below and from the drawings.

FIG. 1 shows a principle sketch for the construction of illuminating devices according to the disclosure.

FIG. 2 shows a principle sketch of a motor vehicle according to the disclosure.

FIG. 3 shows a perspective view of a seat of the motor vehicle.

FIG. 4 shows a view of an illuminating device according to the disclosure installed in a seat.

### DETAILED DESCRIPTION

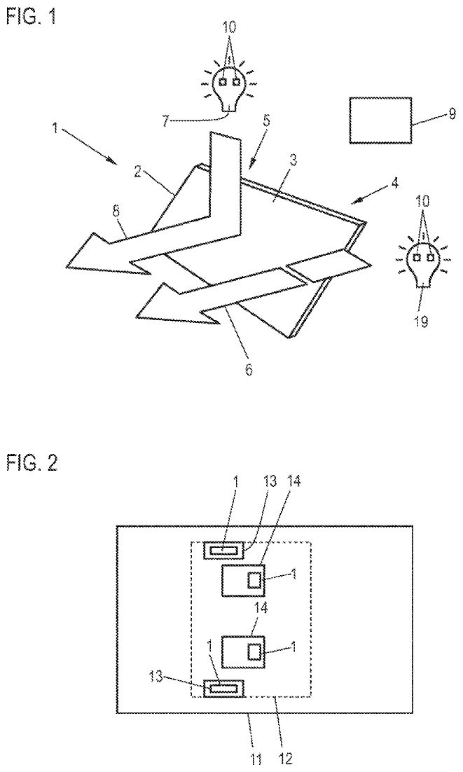

FIG. 1 shows a drawing that illustrates the basic principle of an illuminating device 1 according to the disclosure. The illuminating device 1 has a passive lighting element 2, which provides a lighting surface 3. The lighting surface 3 or alternatively the lighting element 2 is shown at an angle. The lighting surface 3 is translucent in a region 4 defining a first lighting pattern and configured to be reflective in at least one region 5 defining a second lighting pattern. The translucent region 4 and the reflective region 5 are, here, only shown next to each other for better explanation; typically, complex first and second lighting patterns can be defined that interlock, are interwoven and/or even overlap.

The illuminating device 1 now has a first light source 19 that, with respect to an outer side, is arranged behind the lighting element 2, the light of which, as indicated by the arrow 6, permeates through the lighting element 2 in a light-exit direction in the translucent region 4 of the lighting surface 3, such that the first lighting pattern becomes visible. The translucent region 4 is designed to diffuse light from the first light source 19 such that uniform illumination occurs. This can be achieved, for example, by light guide properties and/or suitable dispersing centers and/or suitable surface structuring.

In this case, a second light source 7 is arranged above the lighting element 2, so that its light strikes according to the arrow 8 on the outside of the lighting element 2 and is reflected there in the light-exit direction in the reflective region 5, such that the second lighting pattern becomes visible through this indirect lighting. In so doing, the second light source 7 is, however, installed in a concealed manner.

Both the reflective properties of the reflective region 5 and the translucent properties of the translucent region 4 can be generated by a material treatment which, among other things, also ensures that the first lighting pattern and the second lighting pattern are not recognizable from the outside when the light sources 19, 7 are switched off. Laser treatment techniques and/or etching techniques can be used here, for example, to realize complex first and second light patterns with high precision. This can be done by treating the material of a base body of the lighting element 2 itself; however, it is also conceivable that the base body is provided with a layer, for example, a layer of paint, which is subjected to local material treatment to produce the desired reflective and/or translucent properties. It is also conceivable to use layers that are different on a local basis in the region of the lighting surface 3.

Designs are conceivable in which certain properties or alternatively light impressions, in particular ones that are different for the first subsystem consisting of first light source 19 and translucent region 4 and for the second subsystem consisting of second light source 7 and reflective region 5, are already statically defined in that the translucent and reflective regions 4, 5 are configured to generate different light impressions and/or the first and second light sources 19, 7 emit light with at least one different property. The different properties can include light diffusion across the regions 4, 5 and generally light color and/or color temperature and/or luminous intensity.

The light sources 19, 7 can, however, be controlled with particular advantage, to change at least one property of the emitted light, in particular the light color and/or the color temperature and/or the light intensity, for which purpose the illuminating device has a control unit 9. By controlling the light sources 19, 7 using the control unit 9, different light impressions and light manifestations can be achieved not only by switching the light sources 19, 7 on and off, but also by using different light colors, color temperatures and/or light intensities. In particular, the control unit 9 is configured for dynamic operation of at least one of the light sources 19, 7 to create a dynamic light impression of the lighting surface 3.

As indicated in FIG. 1, the first light source 19 and the second light source 7 can comprise LEDs 10, wherein the second light source 7 in particular can be designed to be extended in at least one direction, for example, as an LED array and/or LED matrix, in particular as an LED strip, in order to illuminate the second lighting pattern in the reflective region 5 as uniformly as possible.

FIG. 2 shows a principle sketch of a motor vehicle 11 according to the disclosure, which comprises an interior compartment 12 for occupants, which is to say, an interior. Illuminating devices 1 according to the disclosure, in this case for generating ambient light, are installed both in trim parts 13 and in the backrests of seats 14.

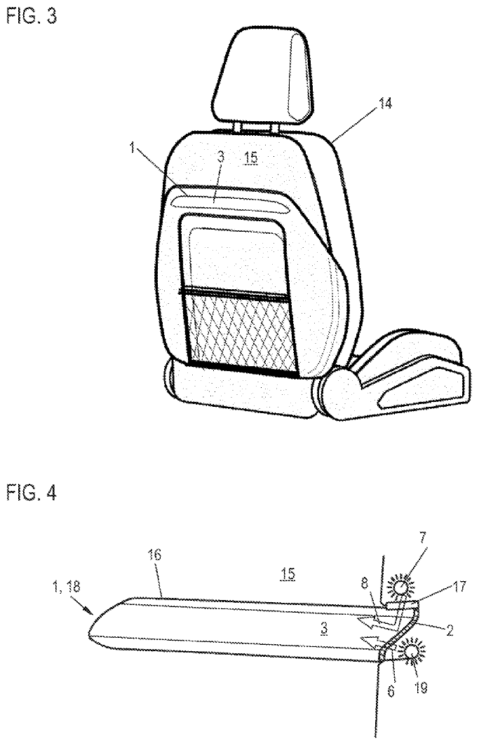

FIG. 3 shows a perspective view of one of the seats 14. The illuminating device 1 is integrated into a trim part on the rear of a backrest 15 such that the light surface 3 is visible to an occupant in the rear seat.

In this respect, FIG. 4 shows a partial cross-sectional view in the region of the lighting element 1, which in the present case is realized as a light module with a generally curved support 16, which comprises the lighting surface 3, which is again inclined, and thus the lighting element 2. Both the first light source 19 and the second light source 7 are borne by the support 16, wherein, for an installation in a concealed manner of the second light source 7, the support 16 can have a window 17 that is only translucent in one direction. In the present case, both the second light source 7 and the light source 19 are configured as LED strips that extend over the length of the illuminating device 1. It should be noted that installation in a concealed manner can also be achieved if the LED strip is installed directly instead of the window 17, inasmuch as the second light source 7 is then not in the usual field of vision of an occupant. It should be noted that the support 16 can also have a shoulder or alternatively a projection in front of the region of such a directly installed second light source 7 in order to conceal it.

Obviously, the support 16 of the light module 18 has a surface that continues the surface of the backrest 15, which is also to be understood here as the trim part 13, and encompasses the lighting surface 3.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. An illuminating device of an interior of a motor vehicle, comprising:
a passive lighting element which defines an outer lighting surface having a light-emission direction; and
at least two light sources which can be switched differently,
wherein a first light source of the at least two light sources shines through the passive lighting element in the light-emission direction for illumination,
wherein in order to define the outer lighting surface, the passive lighting element is configured to be translucent in the light-emission direction in at least one region defining a first lighting pattern and configured to be reflective in at least one region defining a second lighting pattern, and
wherein a second light source of the at least two light sources is provided for illuminating-the-an outside of the passive lighting element such that light from the second light source that hits the passive lighting element from the outside is reflected in the light-emission direction by the reflecting region, and
wherein, at least in the translucent region, the passive lighting element designed such that the first lighting pattern and/or the second lighting pattern is not recognizable from the outside when the first light source is switched off.

2. The illuminating device according to claim 1, wherein the non-recognition is brought about by a material treatment selected for the creation of the translucent region and/or the reflective region.

3. The illuminating device according to claim 1, wherein the translucent region is light-diffusing for light from the first light source.

4. The illuminating device according to claim 1, wherein the reflective and translucent regions at least partially overlap and/or that the lighting patterns on the lighting surface are interwoven.

5. The illuminating device according to claim 1, wherein the translucent and the reflective regions are configured to produce different light impressions.

6. The illuminating device according to claim 1, wherein the first and second light sources emit light of at least one different property.

7. The illuminating device according to claim 1, further comprising at least one control unit for controlling the operation of the at least two light sources.

8. The illuminating device according to claim 7, wherein at least one of the at least two light sources is controllable in order to change at least one property of the emitted light therefrom, and/or the control unit is configured for dynamic operation of at least one of the at least two light sources in order to create a dynamic light impression of the lighting surface.

9. The illuminating device according to claim 1, wherein the first light source and/or the second light source comprise(s) at least one LED and/or is extended in at least one direction.

10. The illuminating device according to claim 1, wherein the passive lighting element is inclined relative to a horizontal and a vertical at least in the region of the lighting surface, and the second light source is arranged above the lighting surface.

11. The illuminating device according to claim 1, wherein the illuminating device is configured as a light module with a support that encompasses the lighting element, to which support the first and second light sources are fastened.

12. The illuminating device according to claim 11, wherein the light module is configured for insertion into a trim element of the motor vehicle, and wherein the support has a surface which continues a surface of the trim part and comprises the lighting surface.

13. The illuminating device according to claim 1, wherein the second light source is installed in a concealed manner.

14. A motor vehicle comprising at least one illuminating device according claim 1.
